(19) United States
(12) Patent Application Publication
(10) Pub. No.: US 2010/0326040 A1
(43) Pub. Date: Dec. 30, 2010

(54) Bird and debris guand for a jet engine

(76) Inventor: Robert Alfred, Bascom, FL (US)

Correspondence Address: Robert A. Crandall, 6045 Neals Landing Road, Bascom, FL, 32423, US

(21) Appl. No.: 12/459,277

(22) Filed: Jun. 30, 2009

(51) Int. Cl. F02G 3/00

(52) U.S. Cl. 60/39.092

(57) ABSTRACT

This guard can be built of this wire material and put in frame so that it fits In the air intake of the jet engine to stop any bird or a piece of debris being sucked in. This would include not only commercial or any jet aircraft that has a frontal air intake including military or any other manufacture of aircraft that uses jet engines for power.

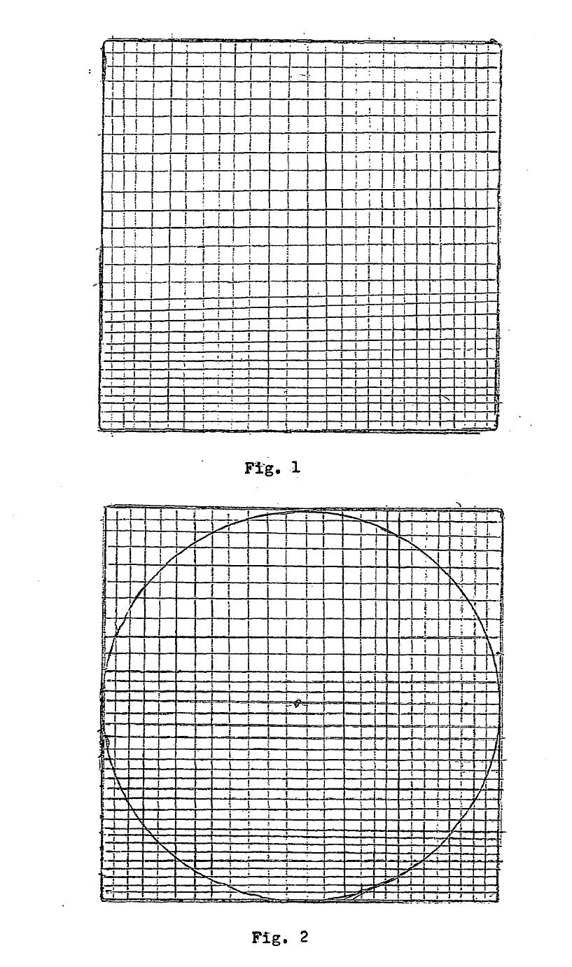

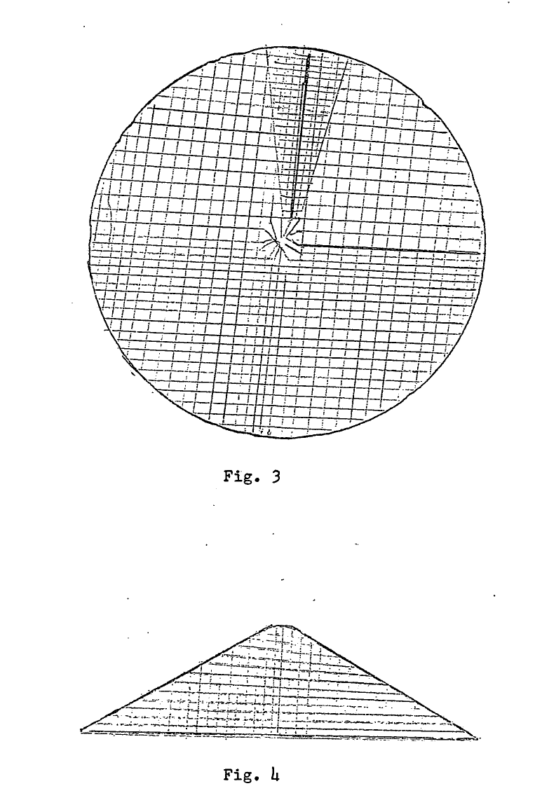

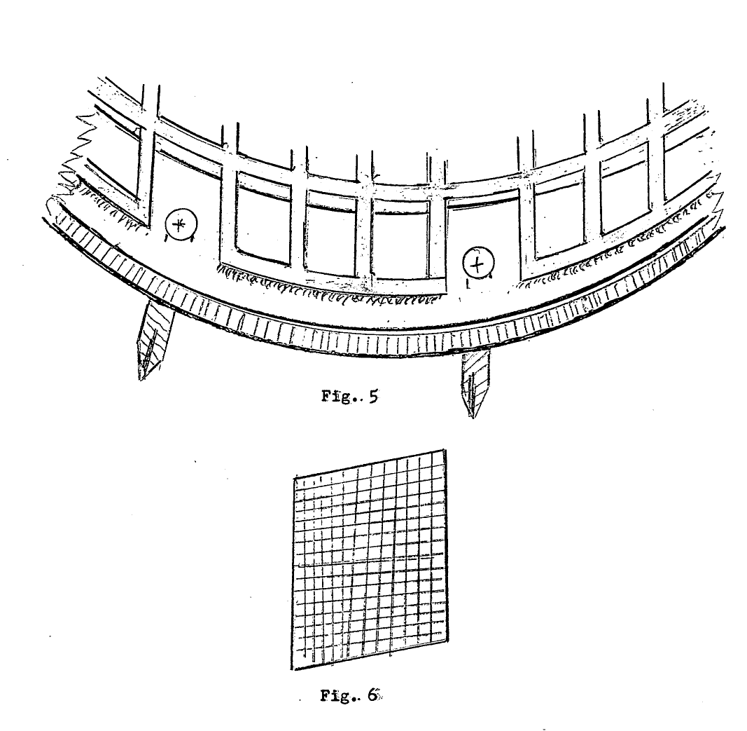

### BACKGROUND OF THE INVENTION

All previous inventions were made by piece by piece construction and were very expensive and time to build. There were 3800 bird strikes between 1990 and 2001 that were reported and there have been many more since (1 on the Hudson river for one) with heavy damage and some with the loss of life. I found out that these could be made out of off the shelf material and assembled in just a few days at a substantial lower cost.

### DESCRIPTION OF PRIOR ART

I will enclose a copy of a list of previous Patents which some are a as old as 1953 but the last one I could find was U.S. Pat. No. 5,411,224 issue issued May 1995 and expired in May 2, 1999 and that consisted of rings and rods which would take a considerable time and money to construct. So I didn't think that there was any need to go to each one to find faults.

### SUMMARY OF THE INVENTION

Its very simple you find the size of the air intake nodule of the jet engine than make a guard large enough so it can rest on the cowl and once that is determined, than you will know what size of material you need. Than take the radius of that circle and the hypotenuse of that circle at 30 Deg. times 2 will give you the size material you need to cut the circle from. When this is done take the circle of material and cut it from the center to the outer edge (and at this point you should cut some small cuts at the center) now you can take the two bottom corners and bring them around until they over lap to form the size cone you want. And once this is done you will have a cone with 30 Deg. sides and now you can cut the portion where it's over laps and weld it together. Now you can finish off the top so that it is oval and finally this can be welded to a ring at the bottom and when it is completed and can be fitted to the cowl of the engine.

The size of the wire and opening can be determined by the user but I suggests that a wire size of about 0.250 ins. And use a 2×2 in. opening because a 14 lb bird hitting the plane at from 125 to 150 miles per hour takeoff speed would be equivelent to 1000 lbs. but might bend the guard slightly but not penetrate it. The drawings will better explain how this can be accomplished.

### A DESCRIPTION OF THE DRAWINGS

Is a section preferably Stainless steal wire about no. 4 in size with a 2×2 inch welded grid, this can be purchased from a wire supplier in any size needed. According to the size needed you have to determine the size of the guard you are going to make, than take the length of the Hypotenuse at 30 Deg. and double that and this will give you the size of material needed.

This shows cutting a circle out of this material the full size which is Larger than the cone shape you want similar to a chef making a cone for frosting.

Next you cut the material from the center to the outer edge also make a few small cuts at the center now you can bring the two cut edges around until they overlap so it will form a cone the size that you want. This will also give the 30 Deg. sides that you are looking for. Once this is done cut the extra material where it overlaps and weld the two ends together also finish the top of the cone.

Shows the finished cone or guard.

This can be welded to a ⅜ inch thick by 2 inch stainless steal ring of which would fit on the face of the cowl of the jet engine and the guard could be easily changed if damaged.

Is a shape that could be used on military aircraft air intake.

1. Considering the number of bird strikes that have occurred and the amount of damage that is inflicted when a bird or some other debris gets in the jet engine there had to be some guard that could be built out of existing materials in a short turn around time and with an exuberant cost. There are not only the cost to the aircraft but there have numerous lives lost due to this problem. The problem is getting because these new jets make less noise and there more birds.
